(19) United States
(12) Patent Application Publication
(10) Pub. No.: US 2025/0307691 A1
(43) Pub. Date: Oct. 2, 2025

(54) ASSISTED PARTIAL TIMING SUPPORT ARTIFICIAL INTELLIGENCE

(71) Applicant: CIENA CORPORATION, Hanover, MD (US)

(72) Inventors: Kevin Estabrooks, Gloucester (CA); Gregory Vanderydt, Stittsville (CA); Ciaron Gogarty, Scarborough (CA)

(73) Assignee: CIENA CORPORATION, Hanover, MD (US)

(21) Appl. No.: 18/617,845

(22) Filed: Mar. 27, 2024

(51) Int. Cl. G06N 20/00; G06N 5/022

(52) U.S. Cl. CPC G06N 20/00; G06N 5/022

(57) ABSTRACT

A predictive artificial intelligence (AI) engine is trained phase offsets measured between global network satellite system (GNSS) derived clocks and precision timing protocol (PTP) derived clocks and network parameters including network impairment metrics in a packet network. The predictive AI engine may predict which PTP input source should be selected by a network element, phase offset(s) to be applied to the PTP input source, and which network element(s) should apply phase offset(s). Other embodiments are disclosed.

### FIELD OF THE DISCLOSURE

The subject disclosure relates to a system and method for using precision timing protocol (PTP) sources in a network.

### BACKGROUND

Today's networks (e.g., 5G radio networks) have extremely accurate timing requirements. These requirements are typically met by deploying GPS antennas and receivers. Unfortunately, GPS antennas and receivers can be susceptible to jamming and extreme environmental conditions. These susceptibilities can be mitigated through the use of a backup timing source that originates from another part of the network. Timing can be delivered across the network via PTP (8275.2 profile) or a combination of PTP and SyncE (8275.1 profile) and provide a backup to GPS. The use of PTP across the network to backup GPS with the 8275.2 profile is known as assisted partial timing support (APTS).

### BRIEF DESCRIPTION OF THE DRAWINGS

Reference will now be made to the accompanying drawings, which are not necessarily drawn to scale, and wherein:

FIG. 1 shows a block diagram illustrating an exemplary, non-limiting embodiment of network elements in a network in accordance with various aspects described herein.

FIG. 2 shows a block diagram illustrating an exemplary, non-limiting embodiment of network elements with PTP offset correction in a network in accordance with various aspects described herein.

FIGS. 3A and 3B depict illustrative embodiments of methods in accordance with various aspects described herein.

FIG. 4 is a block diagram of an example, non-limiting embodiment of a computing environment in accordance with various aspects described herein.

### DETAILED DESCRIPTION

One or more aspects of the subject disclosure include a device, having a processing system including a processor, and a memory that stores executable instructions that, when executed by the processing system, facilitate performance of operations. The operations may include receiving a first clock reference from a global network satellite system (GNSS); receiving a second clock reference from a packet network; comparing the first clock reference and the second clock reference to determine a first phase offset; and providing the first phase offset to a predictive artificial intelligence (AI) engine to train the predictive AI engine to predict future phase offsets.

Additional aspects include a plurality of differential pairs of transistors having drain nodes coupled to the differential pair of combiner nodes, wherein each differential pair of transistors of the plurality of differential pairs of transistors have source nodes coupled in common to one of a plurality of tail current sources, wherein the first differential pair of transistors is one of the plurality of differential pairs of transistors, and wherein the first tail current source is one of the plurality of tail current sources.

Additional aspects include the predictive AI engine residing inside or outside the device, providing network parameters to the predictive AI engine wherein the network parameters comprise a local clock state, a queue congestion, a packet delay variation, and/or any other network parameters useful to train the predictive AI engine.

Additional aspects include receiving a first predictive phase offset from the predictive AI engine; determining a loss of the first clock reference; and applying the first predictive phase offset to the second clock reference, as well as receiving a third clock reference from the packet network; comparing the first clock reference and the third clock reference to determine a phase offset; and providing the phase offset to a predictive artificial intelligence (AI) engine to train the predictive AI engine to predict future phase offsets.

One or more aspects of the subject disclosure include a device having a global network satellite system (GNSS) receiver to receive a GNSS clock; a packet interface to receive a plurality of precision time protocol (PTP) clock references from a packet network; and a predictive AI engine configured to select a first PTP clock reference of the plurality of PTP clock references when a lock to the GNSS clock is lost.

Additional aspects include the predictive AI engine being further configured to provide a phase offset to be applied to the first PTP clock reference; the device being configured to determine a plurality of phase offsets from the GNSS clock and the plurality of PTP clock references, and to provide the plurality of phase offsets to the predictive AI engine; the device being further configured to provide a plurality of network parameters to the predictive AI engine; each of the plurality of precision time protocol (PTP) clock references being associated with a respective one of a plurality of timing trails, and the plurality of network parameters comprises network parameters associated with each of the plurality of timing trails; and/or plurality of network parameters comprises packet delay variation associated with each of the plurality of timing trails.

One or more aspects of the subject disclosure include a non-transitory machine-readable medium, comprising executable instructions that, when executed by a processing system including a processor, facilitate performance of operations. The operations may include receiving phase offset values from a plurality of boundary clock devices in a packet network, wherein the phase offset values represent differences between global network satellite system (GNSS) derived clocks, and precision time protocol (PTP) derived clocks; receiving network parameters from the plurality of boundary clock devices; and training a predictive artificial intelligence (AI) engine to predict future phase offsets for the plurality of boundary clock devices based on the network parameters.

Additional aspects include receiving a plurality of phase offset values from each of the plurality of boundary clock devices, wherein each of the plurality of phase offset values corresponds to a different one of a plurality of PTP clock sources; training the predictive AI engine to predict which of a plurality of PTP clock sources should be used by one of the plurality of boundary clock devices if one of the GNSS derived clocks is lost; training the predictive AI engine to determine which of the plurality of boundary clock devices should apply a phase offset to a PTP derived clock if one of the GNSS derived clocks is lost; and/or providing the future phase offsets to the boundary clock devices.

Various embodiments described herein enable a network that employs use of Assisted Partial Timing Support (APTS), as referenced in and by ITU-T G.8275.2, to adapt to network impairments such as packet delay variation (PDV) and backup a GPS timing reference with greater topology autonomy, accuracy and duration. Various embodiments may reduce or eliminate the need for, prior to deployment of a network element, expensive test gear, specialized human resources, sparse one-time measurements and resulting over-conservative engineering to ensure that the PDV of network segments along the timing trail are within tolerance required for proper function and accuracy of APTS.

Various embodiments include network elements that are deployed with an active GNSS receiver and are PTP aware, and that collect offset data at granular time intervals. The collected data may be stored locally on the network element and/or delivered to a back office (using tools such as GRPC, Netconf\Yang, SNMP, etc.) regularly for short\medium\long term tabulation.

The offset data from one or multiple network elements along a timing trail may be post processed, and a customer may be alerted (e.g., by management station alarms, events, logs, etc.), where the outcome suggests that the network PDV on the timing trail, or on any network segment within the timing trail, is out of spec to support the accuracy of the APTS clock.

Some embodiments use collected offset data from one or more network elements on the timing trail as input to a predictive artificial intelligence (AI) engine. The AI engine may determine what correction should be applied to a network element at the end of the timing trail to bring the accuracy of the APTS clock within acceptable limits despite the network PDV impairment (i.e. adaptation). Offset corrections determined by the AI engine may be applied to the network element(s) using tools that support configuration changes (e.g., Netconf\Yang, SNMP, etc.).

In some embodiments, the AI engine may determine what correction should be applied to a network element within, but not at the end of the timing trail to bring the accuracy of the APTS clock and downstream APTS clocks within acceptable limits despite the network PDV impairment (i.e. adaptation). Offset corrections determined by the AI engine may be applied to the network element(s) using tools that support configuration changes (e.g., Netconf\Yang, SNMP, etc.).

Also in some embodiments, collected offset data (as well as other PTP related data) from one or more network elements are input to a predictive AI engine along with other network parameters to train the predictive AI engine to predict where to apply future phase offsets (e.g., which network elements will apply the phase offsets), which PTP clock reference may be chosen by a particular network element (e.g., determine the timing trail), and/or the phase offset value(s) to be applied over time.

Also in some embodiments, the AI engine may determine whether a PTP clock reference is a viable backup clock in the event of the loss of a GNSS reference. For example, the AI engine may determine that a particular PTP clock reference is stable as long as a phase offset is applied. Also in some embodiments, the AI engine may determine that a particular PTP clock reference is not stable (e.g., phase varies too much over time) even if a phase offset is applied. Further, the AI engine may determine whether to switch from one PTP backup reference to another PTP backup reference if multiple backup references are present. Also in some embodiments, the AI engine may determine whether to exclude switching to a backup reference if no viable reference is available.

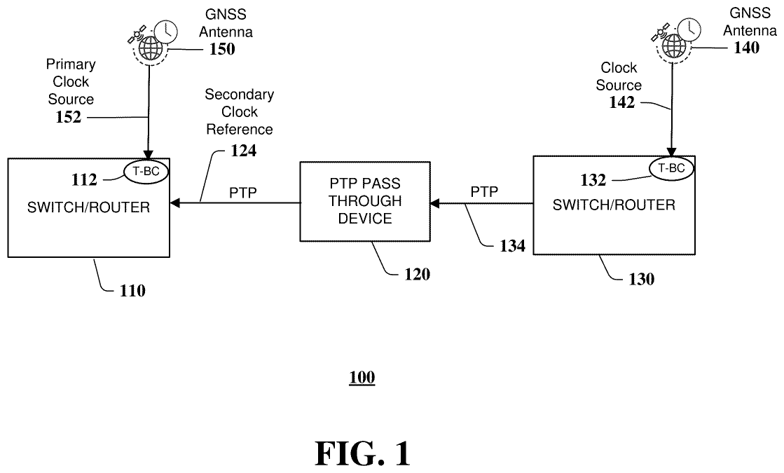

FIG. 1 shows a block diagram illustrating an exemplary, non-limiting embodiment of network elements in a network in accordance with various aspects described herein. System 100 includes network elements 110 and 130, and PTP pass-through device 120. Network elements 110 and 130 are shown in FIG. 1 as switches and/or routers; however, network elements 110 and 130 may be any type of network element in a packet network.

Network element 130 includes a timing boundary clock device 132. In some embodiments, boundary clock device 132 includes a GNSS receiver coupled to GNSS antenna 140. The signal received from GNSS antenna 140 is used as a clock source 142 to derive a clock for operation of network element 130.

Network element 110 also includes a timing boundary clock device 112. Boundary clock device 112 is coupled to GNSS antenna 150, and the signal received from GNSS antenna 150 is used as a clock source 152 to derive a clock for operation of network element 110. The signal received from GNSS antenna 150 is referred to as a “primary clock source,” in part because when a lock to the GNSS system is maintained in manner that allows a reliable clock to be derived therefrom, boundary clock device 112 typically chooses the GNSS system communication as the primary source to derive a clock for operations of network element 110.

In some embodiments, network element 110 may include multiple secondary clock references. For example, network element 110 may include the secondary clock reference 124 provided by network element 130 as well as a tertiary clock reference received from a different network element (not shown). In general, network elements may receive any number of PTP clock references from which the network element may choose in the case of a GNSS failure.

GNSS antennas 140 and 150 may be any antenna capable of communicating with a global network satellite system. For example, GNSS antennas 140 and 150 may communicate with a Global Positioning System (GPS). The terms GNSS and GPS are used interchangeably herein to refer to any suitable GNSS system capable of providing positioning, navigation, and timing (PNT) services on a global or regional basis. In addition, the terms “loss of lock,” “GNSS failure,” “loss of primary clock reference,” and the like all refer to any event that results in the lack of a clock provided by, or derived from, a GNSS system.

In some embodiments, APTS is configured in system 100, and boundary clock devices 112 and 132 may be referred to as “APTS devices.” In these embodiments, network element 130 may provide a PTP clock reference 134 that may provide a secondary clock reference for one or more other network elements (e.g., network element 110) to use in the case of a loss of the primary clock reference. In some embodiments, a PTP clock reference 134 may pass through one or more elements in a packet network that are not aware of the PTP clock reference. In embodiments represented by system 100, such non PTP aware devices are lumped together in PTP pass through device 120. Packets from network element 130 that include the PTP information pass through device 120 and are provided to network element 110 as secondary clock reference 124.

In these embodiments, if the GNSS signal at antenna 150 is lost, the boundary clock device 112 will then lock to the backup PTP input signal provided at secondary clock reference 124. To further the accuracy of the device, while a GNSS lock is present, boundary clock device 112 calculates a phase offset between the incoming GNSS signal and the PTP input on secondary clock reference node 124. When a GNSS signal is lost and a lock to PTP is acquired, the phase offset is applied allowing for a smooth transition to the backup timing source and greater accuracy.

The performance of the backup PTP reference in the event of a GNSS failure may be subject to network conditions and changes in network conditions over time. Precision Time Protocol provides an Announce message that includes information describing the quality level delivered by a PTP timing master (e.g., network element 130), but this control plane guidance is not indicative of the data plane reality around the ability of a PTP slave clock to achieve lock to a PTP reference after the timing information is delivered across a network where network impairments may impede the usefulness of the timing information towards a slave clock achieving lock and the level of timing accuracy required by the application. For example, packet delay variations through device 120 may impede the usefulness of the PTP clock signal on secondary clock reference 124 when a static phase offset is applied by boundary clock device 112.

Various embodiments described herein may include a predictive artificial intelligence (AI) engine capable of predicting phase offsets over time that may be applied to a PTP input signal to mitigate network impairments such as package delay variations. For example, various network elements and boundary clock nodes may provide information (calculated phase offsets, network parameters, etc.) to the predictive AI engine to allow training of the predictive AI engine. Further, the various network elements and boundary clock nodes may receive predictions and/or instructions (e.g., phase offsets, instructions regarding which PTP input to select, etc.) from the predictive AI engine and apply those phase offsets and/or instructions in the event of a GNSS failure. These and other embodiments are further described below.

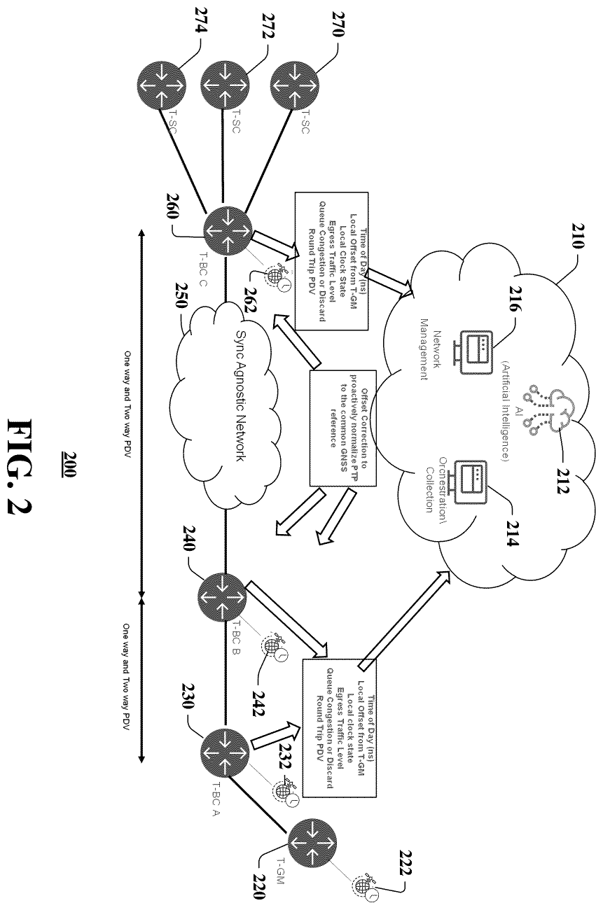

FIG. 2 shows a block diagram illustrating an exemplary, non-limiting embodiment of network elements with PTP offset correction in a network in accordance with various aspects described herein. System 200 includes timing grand master (GM) device 220, boundary clock (BC) devices 230, 240, and 260, slave clock (SC) devices 270, 272, and 274, GNSS antennas 222, 232, 242, and 262, sync agnostic network 250, and network 210. Network 210 includes predictive AI engine 212, network management function 216, and orchestration/collection function 214. Network 210 may be implemented in any manner. For example, in some embodiments, network 210 represents cloud infrastructure capable of implementing predictive AI engine 212 and functions 214 and 216. Also for example, in some embodiments, network 210 represents all or a portion of a communications network core, such as a 5G communications network core.

Although GM device 220, BC devices 230, 240, and 260, and SC devices 270, 272, and 274 are shown in system 200 as standalone devices, in some embodiments, they are included within network elements such as switches and/or routers. Accordingly, reference to timing devices such as GM devices, BC devices, SC devices, and the like may refer to standalone devices used for network timing, and/or any network element or portion of a network element that may include a timing device or a portion of a timing device.

Various embodiments described herein streamline the deployment process, case customer performance concerns, and improve timing accuracy. In order to improve timing accuracy, various embodiments not only log phase offset values over time for analysis, network parameters such as Time of Day, clock offsets, clock states, measured PDV and network congestion may be fed into predictive AI engine 212 for analysis. AI engine 212 may operate in the cloud, on a network management device, an orchestration server, or locally on a network device (e.g., any of the network devices that include any of GM device 220, BC devices 230, 240, 260, etc.). Various embodiments track network changes over time and correlate changes to phase offsets. Once predictive AI engine 212 has learned the correlation between network changes and phase offsets, corrections can be applied directly in real time to network devices. These corrections can be applied by network management function 216 or orchestration/collection function 214, or applied locally if predictive AI engine 212 is hosted on a network device. In cases where predictive AI engine 212 is hosted in a system other than a network device (e.g., a switch or router), predictive Al engine 212 can apply the corrections in specific places allowing PTP to disseminate the correction throughout the network.

In some embodiments, various network elements within system 200 provide measurements of the phase offset between a received GNSS time signal and the backup PTP signal. For example, boundary clock device 240 may periodically measure a phase offset between a time signal received from GNSS antenna 242 and a backup PTP signal received from boundary clock device 230. Boundary clock device 240 may then provide the measured phase offsets to predictive AI engine 212. In some embodiments, phase offsets are also provided to network management function 216 and orchestration/collection function 214, and a user may be alerted if the phase offsets fluctuate over time. An unstable phase offset may indicate a large PDV on the network and/or an inappropriate backup PTP reference.

In some embodiments, various network elements within system 200 also provide network parameters and measurements of network parameters over time to predictive AI engine 212. For example, various network elements that include boundary clock devices may provide time of day, local offset from a PTP clock, local clock state, egress traffic level, queue congestion, packet discard percentage, and/or round trip PDV to predictive Al engine 212. In some embodiments, the local clock state may signify whether a particular boundary clock device is receiving its clock from GNSS or PTP. Further, if it is receiving a clock from PTP it can be in holdover, in specification, or out of specification. Any type or number of network parameter useful to train predictive AI engine 212 may be provided to predictive AI engine 212 by network elements in system 200. Phase offsets and network parameters may be collected and provided at any granularity (e.g., hundreds of times per second, once per second, etc.) and over any period of time (e.g., days, weeks, months, etc.).

In some embodiments, predictive AI engine 212 is trained to select a best PTP reference for a network element to select as a backup clock reference. For example, although system 200 shows a single timing trail proceeding from grandmaster 220 through boundary clock devices 230, 240, and 260, any single network element, such as boundary clock device 260, may receive multiple secondary PTP clock references. Without predictions provided by predictive AI engine 212, a boundary clock device that receives multiple secondary PTP clock references might select one of the PTP clock references based on PTP control plane information about the quality of the timing master, which may not reflect the validity of a PTP input reference after the protocol has run across a network with various levels of impairment. Various embodiments described herein keep track of multiple PTP clock references and their associated phase offset values over time and determine which PTP clock reference is best suited for backup. In this example, predictive AI engine 212 may predict which of the multiple secondary PTP clock references should be chosen by boundary clock device 260.

In some embodiments, predictive AI engine 212 may determine the viability of one or more multiple secondary PTP clock references at a network element such as boundary clock devices 230, 240, and 260. For example, multiple PTP clock references may be received by boundary clock device 260, and predictive Al engine 212 may determine that two of the three secondary PTP clock references have large phase variances over time, while the third secondary PTP clock reference has a stable phase offset over time. In this example, predictive AI engine 212 may determine that boundary clock device 260 should switch to the third secondary PTP clock reference. Also in some embodiments, predictive AI engine 212 may command a network element such as boundary clock device 260 to switch to a different secondary PTP clock reference if multiple are present. Continuing with the previous example, predictive AI engine 212 may determine over time that the first of the three secondary PTP clock references has become more stable than the third, and may command boundary clock device 260 to switch to the first secondary PTP clock reference from the third secondary PTP clock reference. Also in some embodiments, predictive AI engine 212 may determine that a network element such as boundary clock devices 230, 240, and 260, do not have any viable secondary PTP clock references, and may exclude the corresponding network element from switching to a backup reference.

A real concern for network providers is the case where a GPS signal may be spoofed, and a network is brought down. To guard against this, a network operator may monitor GPS signal levels and identify an anomaly. As attackers become more sophisticated, power levels may be adjusted to avoid detection. Various embodiments described herein monitor PTP input references and collect real time data such as phase offsets in multiple references that may be used by predictive AI engine 212 to detect the presence of a spoofed GPS.

In some embodiments, predictive AI engine 212 may predict times at which GPS circuits may be powered down to save power because the confidence in the PTP backup system is high. For example, if at a given time predictive AI engine 212 predicts that each boundary clock device has a good choice of PTP clock reference that has high confidence of phase offsets to be applied, the system may power down GPS circuits and allow APTS to provide clock references. In these embodiments, network providers have the option to power down GPS receivers if it is determined that PTP inputs (primary and backup) provided a stable reference over time. For example, if a particular network element receives the same clock source in triplicate (2 PTP input references and a GPS input), there is little reason to keep the GPS input continuously active consuming energy and shortening the “end of life” of hardware components.

Various embodiments also provide deployment flexibility. One of the values of using PTP based on the G.8275.2 standard is to be able to transport timing information across packet networking devices that are not equipped with timing features and are therefore dubbed “sync agnostic” (e.g., sync agnostic network 250, PTP pass through device 120, etc.). ITU-T standards currently suggest that G.8275.2 PTP traffic should traverse a path, congruently between master (e.g., GM 220) and slave (e.g., BC 260), of not more than 1-2 sync agnostic hops so as to mitigate the impact to timing performance that more sync agnostic hops along the timing trail are likely to introduce. This often makes the network synchronization design a topology bottleneck for service reach beyond the CO\data center. It also precludes traversing a third-party transport service where the number of hops within and the exact set of devices that the timing traffic traverses in each direction between master and slave is not known. Various embodiments described herein improve the number of sync agnostic hops a G.8275.2 PTP timing trail can traverse as well as provide greater flexibility to traverse third party transport networks by applying an AI driven correction scheme at the slave based on collection of offset data at various points in the network, including at the input and output boundaries of third-party transport networks.

The timing flow shown in FIG. 2 is from right to left starting with the grandmaster device 220 providing the clock to the boundary clock devices 230, 240, 260 which may retime the signal. The slave clocks devices 270, 272, 274 are at the end of the chain and receive timing information from boundary clock device 260. In some embodiments, multiple boundary clock devices provide clocks to slave clock devices. FIG. 2 shows a linear network where one boundary clock device feeds another in a particular timing trail. This provides a simplified view, however in some embodiments, each boundary clock device is fed PTP inputs from multiple other boundary clock devices in a mesh network fashion. In some embodiments, one of the PTP inputs may be selected over another based on various factors. For example, the predictive AI engine may evaluate phase offsets over time for each PTP input and determine that one of the PTP inputs is a better reference than others. In some embodiments, the quality of a PTP reference may be determined based on phase offset fluctuations over time, packet data variations over time, or any other metric suitable for predictive AI engine 212 to make the decision. In further embodiments, a clock source may be selected based on historical variations within a timing trail associated with the particular clock reference. For example, a particular clock reference may traverse links or nodes that at a particular time of day may exhibit fluctuations. Although at the time of a loss of a GNSS lock, a particular PTP reference may appear to be stable, predictive AI engine 212 can predict that at some point in the future that particular clock reference may become unstable, and that may be used as a reason to select against that particular clock reference.

Accordingly, predictive AI engine 212 may select a suitable PTP clock reference for a network element, and may also provide suitable phase offsets for the selected PTP input over time. The suitable phase offset may be modified by predictive AI engine 212 over time based on all other features continuously fed into the AI engine as described above.

Although a large mesh network may exist, and any particular PTP clock may follow one of many different possible timing trails, once a PTP clock input is chosen at each network element or boundary clock device, a timing trail is effectively selected. The “timing trail” for timing over packet networks is generally a reference to the trail of links and packet network devices that comprise the path to the ultimate timing source. For example, the timing trail shown in FIG. 2 represents a possible timing trail after one or more of the network elements experiences a GNSS failure. Once a boundary clock device selects a PTP input, the timing trail is the list of hops that it traces back to its ultimate timing source, which is often a grandmaster (e.g., GM 220). In some embodiments, the term “timing trail” refers to the next hop master, which in the example of FIG. 2, corresponds to boundary clock device 240 from the perspective of boundary clock device 260.

Prior to a GNSS failure, each possible timing trail has a different set of nodes and links that may have different impairments such as packet delay variations, and the suitability of a reference may be impacted by the characteristics of a potential timing trail, whether it be more hops or a hop that is more congested or a hop that has asymmetric link distances. Network parameters and calculated phase offsets influenced by all possible timing trails are fed to predictive AI engine 212 for training and for continued predictions after a GNSS failure.

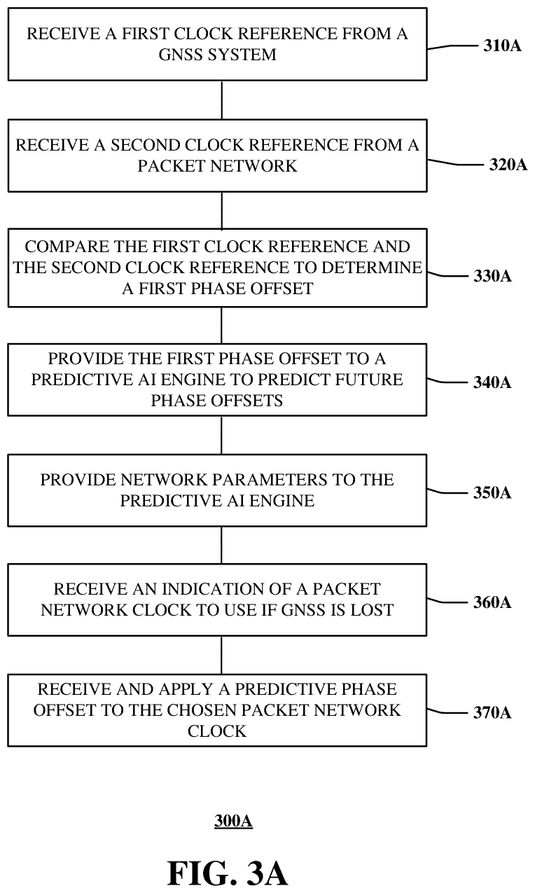

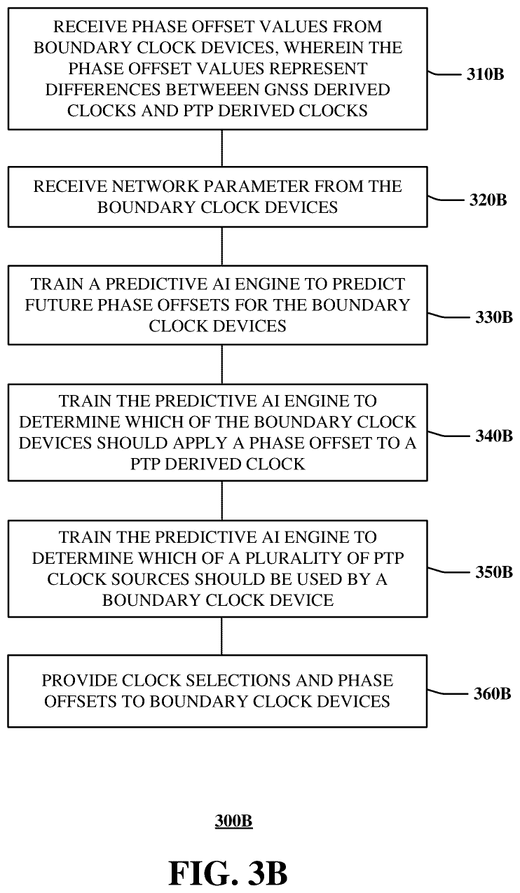

FIG. 3A depicts an illustrative embodiment of a method in accordance with various aspects described herein. At 310A of method 300A, a first clock reference is received from a GNSS system. In some embodiments, this corresponds to a network element such as network elements 110 and 130 (FIG. 1) receiving a timing signal from a GNSS system to derive a clock. Also in some embodiments, this corresponds to a timing grandmaster device or boundary clock device such as those shown in FIG. 2 deriving a clock from a timing signal received from a GNSS system.

At 320A, a second clock reference is received from a packet network. As shown in FIG. 1, network element 110 receives a secondary clock reference 124 as a PTP clock reference, and as shown in FIG. 2, the various boundary clock devices receive PTP timing references from other network elements in the timing trail. In some embodiments, each network element may receive more than one secondary clock reference from other nodes in a packet network. For example, boundary clock device 260 (FIG. 2) may receive one PTP clock reference that has passed through sync agnostic network 250, and may receive another PTP clock reference that has not passed through sync agnostic network 250.

At 330A, the first clock reference and the second clock reference are compared to determine a first phase offset. In various embodiments described herein, while a network element has a lock to a GNSS timing signal, the network element may compare the clock derived from the GNSS system to the one or more PTP clock references received within the packet network. In some embodiments, these comparisons are made periodically over a period of time. Examples include determining these phase offsets eight times every second, hundreds of times every second, or with any other periodicity. Further, they may be determined over a period of days, weeks, months, or indefinitely.

At 340A, the first phase offset is provided to a predictive AI engine to predict future phase offsets. For example, referring now back to FIG. 2, each of boundary clock devices 230, 240, and 260 may provide the phase offsets determined at 330A to predictive AI engine 212. In some embodiments, predictive AI engine 212 resides outside of each individual network element. For example, as shown in FIG. 2, predictive AI engine 212 may reside in the cloud and is outside of boundary clock devices 230, 240, and 260. In some embodiments, one or more of boundary clock devices 230, 240, and 260 include a predictive AI engine. In these embodiments, the phase offsets determined over time by the various boundary clock devices are provided to a local predictive AI engine within the network element. For example, boundary clock device 260 may have a predictive AI engine that resides locally, and the phase offsets determined over time by boundary clock device 260 may be provided to the predictive AI engine that is within boundary clock device 260. Also for example, boundary clock device 240 may have a predictive AI engine that resides locally, and the phase offsets determined by boundary clock device 240 may be provided to the predictive AI engine that is included locally within boundary clock device 240.

At 350A, network parameters are provided to the predictive AI engine. In some embodiments, this corresponds to multiple network elements providing network parameters to predictive AI engine 212. For example, each of boundary clock devices 230, 240, and 260 may provide network parameters that describe the operation or describe quality metrics useful for predictive AI engine 212 to predict future phase offsets. For example, orchestration/collection function 214 may collect various network parameters such as time of day, local offsets from timing grandmaster, local clock states, egress traffic levels, queue congestion or discard rates, or round trip packet delay variations from one or more network elements within the system. These network parameters and metrics may be provided along with calculated phase offsets to predictive AI engine 212 to train the engine to predict future phase offsets based on current or predicted network conditions and or network impairments. In some embodiments, one or more predictive AI engines are included within network elements, and the network parameters provided at 350A correspond to network parameters that are visible locally from the network element in which the predictive AI engine is instantiated. For example, boundary clock device 260 may include a predictive Al engine, and measured phase offsets within boundary clock device 260 as well as locally measurable network parameters may be provided to the Al engine.

At 360A, an indication of a packet network clock to use if GNSS is lost is received. In some embodiments, this corresponds to a predictive AI engine providing an instruction to a network element or boundary clock device regarding which of multiple PTP input references should be selected in the event of the loss of a primary clock source. In some embodiments, this indication is received periodically over time prior to the loss of a GNSS clock. For example, a predictive AI engine may determine that a first PTP input has the highest quality at a particular network element, and may instruct that network element to select that particular PTP input should the primary clock be lost. Prior to the loss of the primary clock, the predictive AI engine may determine that network conditions have changed and that a different PTP input should be selected should a GNSS clock be lost. In this example, the predictive AI engine will modify the indication of the packet network clock to be used should the GNSS clock be lost. Further, in some embodiments, the actions of 360A correspond to a centralized predictive Al engine providing indications to a plurality of network elements, and also in some embodiments the actions of 360A correspond to a predictive AI engine within a network element providing the indication to that particular network element regarding which of multiple PTP inputs should be selected in the case of the loss of a primary clock source.

At 370A, a predictive phase offset is received and is applied to the chosen packet network clock. In some embodiments, predictive phase offsets are received by network elements periodically over time regardless of whether the primary clock source is functioning or has been lost. For example, predictive AI engine 212 may provide predictive phase offsets for a plurality of PTP input clocks at a particular boundary clock device prior to the loss of a GNSS clock. Those phase offsets may be applied to the various PTP input clocks, such that should a GNSS clock be lost, any one of the PTP inputs may be selected (using the indication at 360A) to provide a high quality PTP clock using APTS.

FIG. 3B depicts an illustrative embodiment of a method in accordance with various aspects described herein. At 310B of method 300B, phase offset values are received from boundary clock devices, wherein the phase offset values represent differences between GNSS derived clocks and PTP derived clocks. In some embodiments, this corresponds to orchestration/collection function 214 or predictive AI engine 212 receiving phase offset values determined by one or more boundary clock devices, such as boundary clock devices 230, 240, and 260. In some embodiments, the phase offsets received correspond to multiple phase offsets received from at least one boundary clock device that receives multiple PTP inputs and a single GNSS input.

In some embodiments, the actions of 310B correspond to a predictive AI engine within a boundary clock device or a network element receiving phase offset values corresponding to the difference between the GNSS clock and one or more PTP input clocks received at the network element or boundary clock device within which the predictive AI engine is instantiated.

At 320B, one or more network parameters are received from the boundary clock devices. In some embodiments, a centralized predictive Al engine, such as predictive AI engine 212 receives network parameters from multiple network elements or boundary clock devices. As shown in FIG. 2, the network parameters may include any parameter or metric that describes current operation or impairment at one or more nodes within a packet network. Also in some embodiments, a predictive AI engine that is included within a network element or boundary clock device may receive network parameters that are visible from that network element or boundary clock device. In general, any network parameter may be provided to any predictive Al engine.

At 330B, a predictive AI engine is trained to predict future phase offsets for the boundary clock devices. In some embodiments, this corresponds to predictive AI engine 212 utilizing the phase offset values received at 310B and the network parameter values received at 320B to train the predictive Al engine to predict future phase values as a function of the future network parameter values. At 340 B, the predictive AI engine is trained to determine which of the boundary clock devices should apply a phase offset to a PTP derived clock. In some embodiments, this corresponds to predictive AI engine 212 being trained to determine which of boundary clock devices 230, 240, and 260 should apply a phase offset once the complete timing trail is chosen in the event of a loss of a primary clock source. For example, predictive AI engine 212 may determine that boundary clock device 240 should apply a phase offset in the event of a primary clock source failure, and boundary clock device 260 should not apply a phase offset in the event of the same loss of the primary clock source. In another example, predictive AI engine may determine that boundary clock device 260 should apply a phase offset and the remaining boundary clock devices should not apply a phase offset.

At 350B, the predictive AI engine is trained to determine which of a plurality of PTP clock sources should be used by a boundary clock device. For example, when the phase offset values received at 310B represent phase offset values for multiple PTP input references at a particular boundary clock device or network element, the predictive AI engine may be trained to select one of those PTP input references at the network device or boundary clock device in the event of the loss of a primary clock source.

At 360B, the clock selections and phase offsets are provided to boundary clock devices. As described above, in some embodiments, the clock selections and phase offsets are provided periodically over time regardless of whether a primary clock source has been lost. For example, if all nodes that receive GNSS clock references are receiving high quality clocks from a GNSS system, they may still receive clock selections and phase offsets at 360B, and still continue to use the primary clock sources provided by GNSS. If, however, the GNSS clock is lost, the boundary clock devices have clock selections and phase offsets ready to go and a seamless transition to a PTP clock reference can be made by applying the clock selections and the phase offsets. This applies in the case of a centralized predictive AI engine that communicates with multiple boundary clock devices, as well as one or more predictive AI engines included within boundary clock devices that have more local control of each boundary clock device separately.

While for purposes of simplicity of explanation, the respective processes are shown and described as a series of blocks in FIGS. 3A and 3B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein. Note, one or more blocks can be performed in response to one or more other blocks.

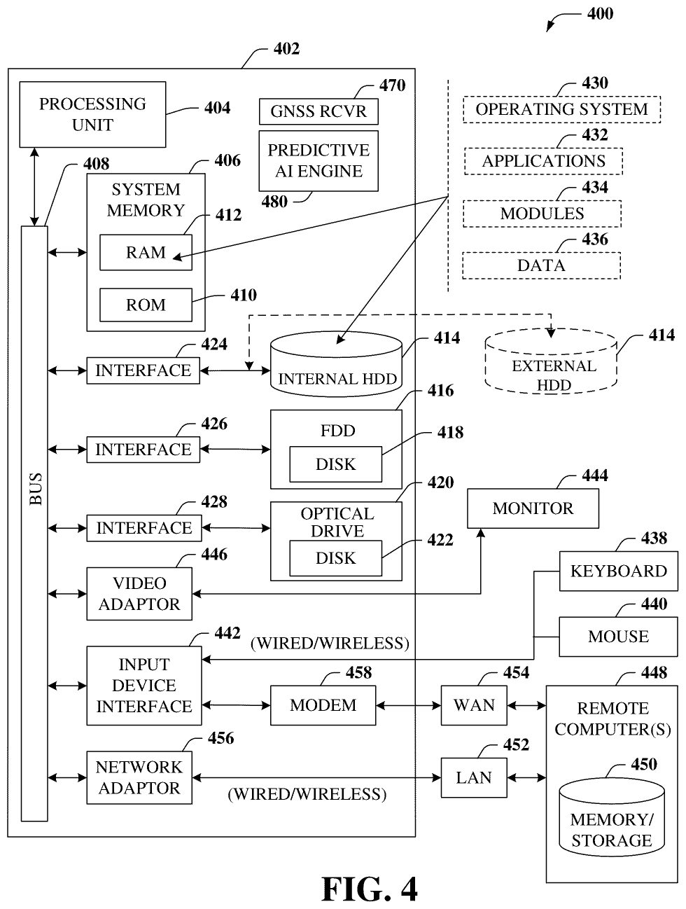

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a computing environment 400, when combined with specific equipment such as a GNSS receiver, a timing subsystem including PLL, etc., a forwarding switch/ASIC for Ethernet or IP/MPLS processing capability to support PTP, etc., that would be suitable for implementing the various embodiments of the subject disclosure. For example, computing environment 400 can facilitate in whole or in part receiving timing information via partial timing support over an Internet Protocol network; and providing an indication of a priority level of an interworking function in an announce packet of precision timing protocol to a downstream node.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. System memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen and the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can also be connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. Modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are examples and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

In some embodiments, computer 402 is included within a network element and or boundary clock device. For example, in some embodiments, computer 402 includes a GNSS receiver 470 that is coupled to receive a timing signal from a GNSS system to operate in a packet network. Also for example, in some embodiments, computer 402 includes predictive AI engine 480 that may be used to predict future phase offsets, a suitable PTP input clock, and predict other quantities useful in APTS enabled networks. Predictive AI engine 480 may be implemented in any manner. For example, in some embodiments, one or more processors within processing unit 404 may be configured to implement predictive AI engine 480 as executable instructions held in system memory 406, or in/on any suitable storage medium. In some embodiments, one or more of the interfaces within computer 402 implement a packet interface for operation in a packet network. For example, network adapter 456 may communicate across a packet network to send and receive packets, some of which include PTP related packets that provide secondary clock sources.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can comprise the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising
receiving a first clock reference from a global network satellite system (GNSS);
receiving a second clock reference from a packet network;
comparing the first clock reference and the second clock reference to determine a first phase offset; and
providing the first phase offset to a predictive artificial intelligence (AI) engine to train the predictive AI engine to predict future phase offsets.

2. The device of claim 1, wherein the predictive AI engine resides within the device.

3. The device of claim 1, wherein the predictive AI engine resides outside the device.

4. The device of claim 1, wherein the operations further comprise providing network parameters to the predictive AI engine.

5. The device of claim 4, wherein the network parameters comprise a packet delay variation.

6. The device of claim 1, wherein the operations further comprise:
receiving a first predictive phase offset from the predictive AI engine;
determining a loss of the first clock reference; and
applying the first predictive phase offset to the second clock reference.

7. The device of claim 6, wherein the determining the loss of the first clock reference comprises determining that the first clock reference has been spoofed.

8. The device of claim 6, wherein the determining the loss of the first clock reference comprises determining that at least one circuit for receiving the first clock reference has been powered down.

9. The device of claim 1, wherein the operations further comprise:
receiving a third clock reference from the packet network;
comparing the first clock reference and the third clock reference to determine a second phase offset; and
providing the second phase offset to the predictive artificial intelligence (AI) engine to train the predictive AI engine to predict future phase offsets.

10. A device comprising:
a global network satellite system (GNSS) receiver to receive a GNSS clock;
a packet interface to receive a plurality of precision time protocol (PTP) clock references from a packet network; and
one or more processors configured to implement a predictive AI engine that is configured to select a first PTP clock reference of the plurality of PTP clock references when a lock to the GNSS clock is lost.

11. The device of claim 10, wherein the predictive AI engine is further configured to provide a phase offset to be applied to the first PTP clock reference.

12. The device of claim 10, wherein the one or more processors is further configured to determine a plurality of phase offsets from the GNSS clock and the plurality of PTP clock references, and to provide the plurality of phase offsets to the predictive AI engine.

13. The device of claim 12, wherein the one or more processors is further configured to provide a plurality of network parameters to the predictive AI engine.

14. The device of claim 13, wherein each of the plurality of PTP clock references are associated with a respective one of a plurality of timing trails, and the plurality of network parameters comprises network parameters associated with each of the plurality of timing trails.

15. The device of claim 12, wherein the predictive AI engine is further configured to determine whether each of the plurality of PTP clock references represents a viable backup clock reference, and to select one of the plurality of PTP clock references only if at least one of the PTP clock references is determined to be viable.

16. A non-transitory machine-readable medium, comprising executable instructions that, when executed by a processing system including a processor, facilitate performance of operations, the operations comprising:
receiving phase offset values from a plurality of boundary clock devices in a packet network, wherein the phase offset values represent differences between global network satellite system (GNSS) derived clocks, and precision time protocol (PTP) derived clocks;
receiving network parameters from the plurality of boundary clock devices; and
training a predictive artificial intelligence (AI) engine to predict future phase offsets for the plurality of boundary clock devices based on the network parameters.

17. The non-transitory machine-readable medium of claim 16, wherein the receiving the phase offset values comprises receiving a plurality of phase offset values from each of the plurality of boundary clock devices, wherein each of the plurality of phase offset values corresponds to a different one of a plurality of PTP clock sources.

18. The non-transitory machine-readable medium of claim 16, wherein the operations further comprise training the predictive AI engine to predict which of a plurality of PTP clock sources should be used by one of the plurality of boundary clock devices if one of the GNSS derived clocks is lost.

19. The non-transitory machine-readable medium of claim 16, wherein the operations further comprise training the predictive AI engine to determine which of the plurality of boundary clock devices should apply a phase offset to a PTP derived clock if one of the GNSS derived clocks is lost.

20. The non-transitory machine-readable medium of claim 16, wherein the operations further comprise providing the future phase offsets to the plurality of boundary clock devices.
